(19) United States
(12) Patent Application Publication
(10) Pub. No.: US 2008/0123291 A1
(43) Pub. Date: May 29, 2008

(54) HEAT-DISSIPATION APPARATUS FOR HARD DISK

(75) Inventors: Frank Wang, Taoyuan County (TW); Chih-Kai Yang, Taipei County (TW)

Correspondence Address: J C PATENTS, INC., 4 VENTURE, SUITE 250, IRVINE, CA, 92618, US

(73) Assignee: INVENTEC CORPORATION, Taipei City (TW)

(21) Appl. No.: 11/675,814

(22) Filed: Feb. 16, 2007

(30) Foreign Application Priority Data
Nov. 23, 2006 (TW) 95143315

(51) Int. Cl. G06F 1/20

(52) U.S. Cl. 361/688

(57) ABSTRACT

A heat-dissipation apparatus for a hard disk is provided, which is adapted for being configured on a hard disk or in a hard disk slot, and includes a heat-conducting layer and at least one heat-conducting pad disposed on a surface of the heat-conducting layer corresponding to the hard disk. The heat-conducting pad contacts the hard disk and the waste heat is conducted from the hard-disk to the heat-conducting layer through the heat-conducting pad, and then transferred outside the hard disk or the hard disk slot through the heat-conducting layer. Therefore, the operating temperature of the hard disk in high speed operation is lowered and the service life of the hard disk is prolonged.

### CROSS-REFERENCE TO RELATED APPLICATION

This application claims the priority benefit of Taiwan application serial no. 95143315, filed Nov. 23, 2006. All disclosure of the Taiwan application is incorporated herein by reference.

### BACKGROUND OF THE INVENTION

1. Field of the Invention

The present invention relates to a heat-dissipation apparatus, and more particularly to a heat-dissipation apparatus for a hard disk.

2. Description of Related Art

Recently, storage capacity of hard disks is improved increasingly and volume of hard disks is miniaturized, so hard disks have been widely used in various portable electronic apparatuses. Meanwhile, according to the requirement for high speed information transmission, reading speed of hard disks and CPUs (central processing units) is increased continuously. However, a large amount of heat is produced after a long-time reading operation, which results in the damage of sectors of the hard disk and the loss of data, and the CPU may shut down due to excessively high operating temperature. Therefore, more and more heat-dissipation mechanisms, for CPU are proposed to eliminate the excessive high temperature of CPU and improving operating performance.

Taking a portable computer as an example, the commonly used heat-dissipation mechanism leads external cold air into the case by using a fan, and then exhausts inside hot air via the heat-dissipation hole through convection. Since operational electronic components such as CPUs and graphic chips are the biggest heat source inside the portable computer, the operating temperature is strictly controlled. However, as for a high speed hard disk producing a small amount of heat the control of the operating temperature is usually ignored, and thus the high speed hard disk usually operates under a high operating temperature. However, the service life of a hard disk is in inverse proportion to the operating temperature of the hard disk. For example, the service life of the hard disk is about 30,000 hours when operating under an operating temperature of 40° C., while the service life of the hard disk is about 20,000 hours when operating under an operating temperature of 50° C.

In view of the above, under the principle of high speed data reading, it is quite important to reduce the operating temperature of the hard disk for prolonging the service life of the hard disk.

### SUMMARY OF THE INVENTION

The present invention is directed to providing a heat-dissipation apparatus for a hard disk, which is used to absorb waste heat produced by the hard disk and transfer the waste heat to the outside.

The present invention provides a heat-dissipation apparatus for a hard disk, which is adapted for being configured on a hard disk. The heat-dissipation apparatus for a hard disk comprises a heat-conducting layer and at least one heat-conducting pad. The heat-conducting layer has a surface corresponding to the hard disk and partly extends out of the hard disk. The heat-conducting pad is disposed on the surface corresponding to the hard disk and contacts the hard disk.

The present invention also provides another heat-dissipation apparatus for a hard disk, which is adapted for being configured in a hard disk slot which is used to place a hard disk. The heat-dissipation apparatus for a hard disk comprises a heat-conducting layer and at least one heat-conducting pad. The heat-conducing layer is disposed in the hard disk slot and partly extends out of the hard disk slot, and the heat-conducting layer has a surface corresponding to the hard disk. The heat-conducting pad is disposed on the surface corresponding to the hard disk and contacts the hard disk.

According to an embodiment of the present invention, the heat-conducting layer extends from a lower surface of the hard disk to a neighboring side surface, and then extends out of the hard disk through the side surface.

According to another embodiment of the present invention, the heat-conducting layer extends from a lower surface of the hard disk to a neighboring side surface, then extends from the side surface to an upper surface of the hard disk, and then extends out of the hard disk through the upper surface.

According to an embodiment of the present invention, the heat-conducting layer extends from a lower surface of the hard disk slot to a neighboring side surface, and then extends out of the hard disk slot through the side surface.

According to another embodiment of the present invention, the heat-conducting layer extends from a lower surface of the hard disk slot to a neighboring side surface, then extends to an upper surface of the hard disk through the side surface, and then extends out of the hard disk slot through the upper surface.

According to an embodiment of the present invention, the heat-conducting layer is selected from a composite material layer constituted by a metal material layer and a graphite layer.

According to an embodiment of the present invention, the heat-conducting layer comprises a graphite layer.

According to an embodiment of the present invention, the heat-conducting layer comprises at least one metal material layer.

According to an embodiment of the present invention, the heat-conducting layer comprises a composite material layer constituted by a graphite layer and at least one metal material layer. Moreover, the above metal material layer comprises an aluminum layer or a copper layer.

According to an embodiment of the present invention, the material of heat-conducting pad comprises graphite or metal. Moreover, the heat-conducting pad comprises at least one upper heat-conducting pad and at least one lower heat-conducting pad. The upper heat-conducting pad contacts the upper surface of the hard disk correspondingly, and the lower heat-conducting pad contacts the lower surface of the hard disk correspondingly.

The present invention adopts a heat-dissipation apparatus for a hard disk having a material of a high heat conductivity, so the waste heat produced by the hard disk when reading data in high speed can be absorbed by the heat-dissipation apparatus and then transferred outside the hard disk or the hard disk slot, so as to reduce the operating temperature of the hard disk and prolong the service life of the hard disk.

In order to make the aforementioned and other objectives, features and advantages of the present invention comprehensible, preferred embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic sectional view of a heat-dissipation apparatus for a hard disk according to the first embodiment of the present invention.

FIGS. 2A and 2B are schematic view of the configuration of the heat-dissipation apparatus for a hard disk of the present invention.

FIG. 3A is a schematic sectional view of the heat-dissipation apparatus for a hard disk according to the second embodiment of the present invention.

FIG. 3B is a schematic view of the configuration of heat-dissipation apparatus for a hard disk of the present invention.

### DESCRIPTION OF EMBODIMENTS

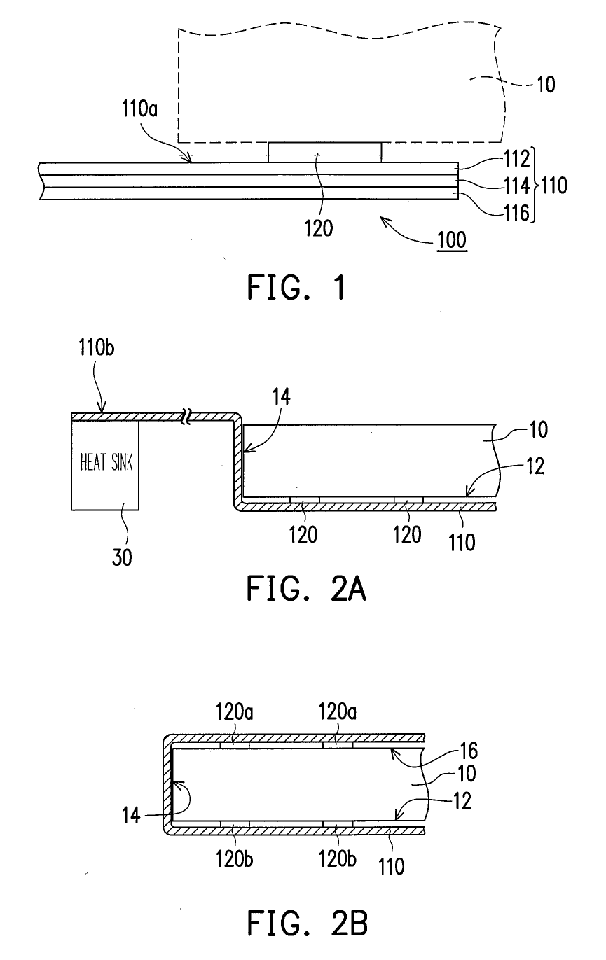

FIG. 1 is a schematic sectional view of a heat-dissipation apparatus for a hard disk according to the first embodiment of the present invention. The heat-dissipation apparatus 100 for a hard disk is adapted to be attached onto the hard disk 10 and includes a heat-conducting layer 110 and at least one heat-conducting pad 120. The heat-conducting layer 110 has a surface 110a corresponding to the hard disk 10, and contacts the hard disk 10 via the heat-conducting pad 120 configured on the surface 110a of heat-conducting layer 110, such that the waste heat is transferred to heat-conducting layer 110 through the heat-conducting pad 120. The heat-conducting layer 110 partly extends out of the hard disk 10 to the surrounding area away from the hard disk 10, so as to reduce the operating temperature of the hard disk 10 when running.

In the present embodiment, the contact position of the heat-conducting pad 120 and the hard disk 10 is not limited, but preferably is a heat concentration, region or each hot spot of the metal case region or the circuit region of the hard disk 10. The temperature of the hot spot on the hard disk 10 is the highest, and the heat-dissipation here is in high demand, so a higher heat-dissipation effect is achieved by directly contacting the heat-conducting pad 120 with the above hot spot.

As far as the material is concerned, the heat-conducting layer 110 and the heat-conducting pad 120 can be composed by a metal material of high heat conductivity and a graphite material. The graphite material has a low heat resistance and a light weight, and the graphite material and the metal material can form a metal-graphite composite material through a powder metallurgy treatment. In this embodiment, the heat-conducting layer 110 is, for example, the composite material of high heat conductivity, which is composed of a first metal layer 112, a graphite layer 114, and a second metal layer 116, for example aluminum-graphite-aluminum, copper-graphite-aluminum, or copper-graphite-copper. However, the combinations of two layers of composite material such as aluminum-graphite, copper-graphite, and copper-aluminum can also be implemented, and thus FIG. 1 of this embodiment is not intended to limit the present invention.

In addition to the multi-layer composite material. The heat-conducting layer 110 can also can be manufactured by a single layer materials, for example a single graphite layer, an aluminum layer, an aluminum alloy layer, a copper layer, a copper alloy layer, or other metal material layers of high heat conductivity, which will not be described herein.

As far as the softness is concerned, the heat-dissipation apparatus 100 for a hard disk adopts soft and thin heat-conducting material, which can be flatly attached onto or overlaid on any planar or curved surface of the hard disk 10, so as to uniformly absorb the waste heat conducted by any surface of the hard disk 10. Moreover, the heat-conducting layer 110 extends outwards through the gap between the hard disk 10 and the surrounding components (not shown) without occupying space.

As shown in FIG. 2A, the heat-conducting layer 110 extends from a lower surface 12 of the hard disk 10 to a neighboring side surface 14, and then extends out of the hard disk 10 through the side surface 14. In this embodiment, the portion 110b of the heat-conducting layer 110 extending out of the hard disk is further connected to a heat sink 30 to improve the heat-dissipation efficiency. The heat sink 30 is, for example, a heat-dissipation structure of any type constituted by cooling fins, a fan and/or a heat pipe.

As shown in FIG. 2B, in another embodiment, the heat-conducting layer 110 extends from a lower surface 12 of the hard disk 10 to a neighboring side surface 14, and extends to an upper surface 16 of the hard disk 10 through the side surface 14, and then extends out of the hard disk 10 through the upper surface 16. Moreover, the allocation and number of the heat-conducting pad 120 are appropriately adjusted. As shown in FIG. 2A, the heat-conducting pad 120 only contacts the lower surface 12 of the hard disk 10. Or, as shown in FIG. 2B, the heat-conducting pad 120 includes an upper heat-conducting pad 120a and a lower heat-conducting pad 120b, the upper heat-conducting pad 120a contacts the upper surface 16 of the hard disk 10, and the lower heat-conducting pad 120b contacts the lower surface 12 of the hard disk 10, so as to enlarge the contact area.

Since the heat-dissipation apparatus 100 for a hard disk of the present invention does not occupy space, compared with other large heat sink, heat pipe, and cooling fins for heat dissipation, the present invention is more adapted for being used in portable electronics apparatuses having limited space, such as a portable computer, a hard disk portable music player, a hard disk external enclosure, or other electronic apparatuses using hard disk to store data.

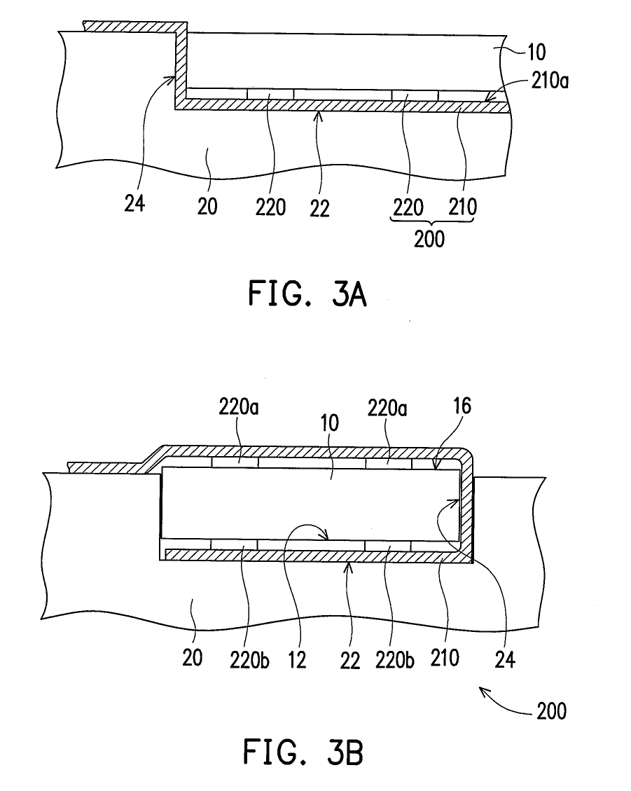

Then, FIG. 3A is a schematic sectional view of a heat-dissipation apparatus for a hard disk according to the second embodiment of the present invention. The heat-dissipation apparatus 200 for a hard disk is adapted for being configured in a hard disk slot 20, which includes a heat-conducting layer 210 and at least one heat-conducting pad 220. The heat-conducting layer 210 is disposed in the hard disk slot 20 and partly extends out of the hard disk slot 20. Moreover, the heat-conducting pad 220 is disposed on a surface 210a of the heat-conducting layer 210 corresponding to the hard disk 10 and contacts the hard disk 10 for absorbing the waste heat. As described in the first embodiment, the heat-conducting layer 210 is a single material layer such as graphite, aluminum, or copper or a composite material layer constituted by a graphite layer and at least one metal material layer, and the material of the heat-conducting pad 220 is graphite or metal.

The details of different allocations will be illustrated with reference to the drawings. Referring to FIG. 3A, the heat-conducting layer 210 is disposed on the lower surface 22 of the hard disk slot 20, and extends from the neighboring side surface 24 to the outside of the hard disk slot 20. As described in the first embodiment, as the heat-conducting layer 210 adopts a soft electrically conductive material, the heat-conducting layer 210 matches the shape of the hard disk slot 20 and can be flatly attached to or overlaid on any planar or curved surface of the hard disk slot 20 without occupying the original space of the hard disk slot 20.

Then, referring to the allocation in FIG. 3B, the heat-conducting layer 210 is disposed on the lower surface 22 of the hard disk slot 20, and extends to the upper surface 16 of the hard disk 10 through the neighboring side surface 24, and then extends from the upper surface 16 of the hard disk 10 to the outside of the hard disk slot 20. As described in the first embodiment, the upper surface 16 and the lower surface 12 of the hard disk 10 respectively contact the upper heat-conducting pad 220a and the lower heat-conducting pad 220b, thus the waste heat on the top and bottom of the hard disk 10 is conducted to the heat-conducting layer 210 respectively through the upper and lower heat-conducting pads 220a, 220b, and then transferred out of the hard disk slot 20 through the heat-conducting layer 210, thus lowering the operating temperature of the hard disk 10.

The heat-dissipation apparatus for a hard disk of the present invention is capable of dissipating heat quickly, lowering the operating temperature of the hard disk, and prolonging the service life of the hard disk, and further has an antishock effect as the soft electrically conductive material is adopted, thereby preventing the sectors of hard disk from being damaged and causing a failure in reading data. Meanwhile, the present invention has a metal shielding effect since the electrically conductive layer is overlaid on the periphery of the entire hard disk, as shown in FIGS. 2B and 3B, so that the interference of electromagnetic wave is avoided and the data reading errors caused by the interference of electromagnetic wave during the running of the hard disk are avoided.

As described in the first embodiment, the heat-dissipation apparatus for a hard disk 200 also can be used together with other heat sinks, cooling fins, heat pipes, or heat dissipation fans or exhaust the waste heat through a natural convection. Therefore, any heat dissipation mechanism designed for heat conduction including heat dissipation % components used in CPU, graphic chip, or other electronic apparatuses can be used together with the heat-dissipation apparatus for a hard disk of the present invention to reduce the operating temperature of the entire electronic system, so as to improve the stability of the system.

In another aspect, if allowed, the heat-dissipation apparatus for a hard disk of the present invention also can be connected to a ground terminal of the metal case or the circuit board so as to further provide a electro-static discharge (ESD) protection function and prevent noise interference in addition to providing the metal shielding effect, such that the hard disk can read data in the sectors stably.

Though the present invention has been disclosed above by the preferred embodiments, they are not intended to limit the present invention. Anybody skilled in the art can make some modifications and variations without departing from the spirit and scope of the present invention. Therefore, the protecting range of the present invention falls in the appended claims and their equivalents.

What is claimed is:

1. A heat-dissipation apparatus for a hard disk, adapted for being configured on a hard disk, comprising:
a heat-conducting layer, having a surface corresponding to the hard disk and partly extending out of the hard disk; and
at least one heat-conducting pad, disposed on the surface of the heat-conducting layer corresponding to the hard disk and contacting the hard disk.

2. The heat-dissipation apparatus for a hard disk as claimed in claim 1, wherein the heat-conducting layer comprises a graphite layer.

3. The heat-dissipation apparatus for a hard disk as claimed in claim 1, wherein the heat-conducting layer comprises at least one metal material layer.

4. The heat-dissipation apparatus for a hard disk as claimed in claim 1, wherein the heat-conducting layer comprises a composite material layer constituted by a graphite layer and at least one metal material layer.

5. The heat-dissipation apparatus for a hard disk as claimed in claim 4, wherein the metal material layer comprises an aluminum layer or a copper layer.

6. The heat-dissipation apparatus for a hard disk as claimed in claim 1, wherein the material of the heat-conducting pad comprises graphite or metal.

7. The heat-dissipation apparatus for a hard disk as claimed in claim 1, wherein the heat-conducting layer extends from a lower surface of the hard disk to a neighboring side surface, and then extends out of the hard disk through the neighboring side surface.

8. The heat-dissipation apparatus for a hard disk as claimed in claim 1, wherein the heat-conducting layer extends from a lower surface of the hard disk to a neighboring side surface, then extends to an upper surface of the hard disk through the neighboring side surface, and then extends out of the hard disk through the upper surface.

9. The heat-dissipation apparatus for a hard disk as claimed in claim 8, wherein the heat-conducting pad comprises at least one upper heat-conducting pad and at least one lower heat-conducting pad, the upper heat-conducting pad contacts the upper surface of the hard disk correspondingly, and the lower heat-conducting pad contacts the lower surface of the hard disk correspondingly.

10. A heat dissipation apparatus for a hard disk, adapted for being configured in a hard disk slot, wherein the hard disk slot is used for placing a hard disk, comprising:
a heat-conducting layer, disposed in the hard disk slot and partly extending out of the hard disk slot and having a surface corresponding to the hard disk; and
at least one heat-conducting pad, disposed on the surface corresponding to the hard disk and contacting the hard disk.

11. The heat-dissipation apparatus for a hard disk as claimed in claim 10, wherein the heat-conducting layer comprises a graphite layer.

12. The heat-dissipation apparatus for a hard disk as claimed in claim 10, wherein the heat-conducting layer comprises at least a metal material layer.

13. The heat-dissipation apparatus for a hard disk as claimed in claim 10, wherein the heat-conducting layer comprises a composite material layer constituted by a graphite layer and at least one metal material layer.

14. The heat-dissipation apparatus for a hard disk as claimed in claim 13, wherein the metal material layer comprises an aluminum layer or a copper layer.

15. The heat-dissipation apparatus for a hard disk as claimed in claim 10, wherein the material of the heat-conducting pad comprises graphite or metal.

16. The heat-dissipation apparatus for a hard disk as claimed in claim 10, wherein the heat-conducting layer extends from a lower surface of the hard disk slot to a neighboring side surface, and then extends out of the hard disk slot through the neighboring side surface.

17. The heat-dissipation apparatus for a hard disk as claimed in claim 10, wherein the heat-conducting layer extends from a lower surface of the hard disk slot to a neighboring side surface, then extends to an upper surface of the hard disk through the neighboring side surface, and then extends out of the hard disk slot through the upper surface.

18. The heat-dissipation apparatus for a hard disk as claimed in claim 17, wherein the heat-conducting pad comprises at least one upper heat-conducting pad and at least one lower heat-conducting pad, the upper heat-conducting pad contacts the upper surface of the hard disk correspondingly, and the lower heat-conducting pad contacts the lower surface of the hard disk correspondingly.
